(19) United States
(12) Patent Application Publication
(10) Pub. No.: US 2017/0176387 A1
(43) Pub. Date: Jun. 22, 2017

(54) DEVICE AND METHOD FOR CALCULATING TRAPPING PARAMETERS BY MEASURING SHORT-CIRCUIT CURRENT DECAY UNDER REVERSE BIAS VOLTAGE

(71) Applicants: State Grid Corporation of China, Beijing (CN); State Grid Henan Electric Power Company Zhengzhou Power Supply Company, Zhengzhou (CN); Henan Epri Electric Technology Co., Ltd., Zhengzhou (CN); Xi'an Jiaotong University, Xi'an (CN)

(72) Inventors: Weizheng ZHANG, Zhengzhou (CN); Zhimin LI, Zhengzhou (CN); Haibao MU, Xi'an (CN); Guojian JI, Zhengzhou (CN); Lin ZHAO, Xi'an (CN); Yuan LI, Xi'an (CN); Wenwei SHEN, Xi'an (CN); Guanjun ZHANG, Xi'an (CN); Furong LIU, Zhengzhou (CN); Peng LU, Zhengzhou (CN)

(21) Appl. No.: 15/450,016

(22) Filed: Mar. 5, 2017

Related U.S. Application Data
(63) Continuation-in-part of application No. PCT/CN2014/086365, filed on Sep. 12, 2014.

(30) Foreign Application Priority Data
Sep. 10, 2014 (CN) 201410458113.6

(51) Int. Cl. G01N 27/60

(52) U.S. Cl. CPC G01N 27/60

(57) ABSTRACT

A device for calculating trapping parameters by measuring short-circuit current decay under a reverse bias voltage, including: a vacuum chamber, an experiment table, a lower electrode, a shielding layer, an upper electrode, a direct current charging module, a switch, a short-circuit measuring system, and a computer. The experiment table, the lower electrode, the shielding layer, the test sample, and the upper electrode are disposed from the bottom up in that order inside the vacuum chamber. The upper electrode is connected to the direct current charging module via the switch. The upper electrode and the lower electrode are electrically connected via the short-circuit measuring system. The short circuit or the detrapping current measuring circuit is selectively electrically connected under the control of the selective switch. The reverse bias voltage source and the microammeter are connected in series.

### CROSS-REFERENCE TO RELATED APPLICATIONS

This application is a continuation-in-part of International Patent Application No. PCT/CN2014/086365 with an international filing date of Sep. 12, 2014, designating the United States, now pending, and further claims foreign priority benefits to Chinese Patent Application No. 201410458113.6 filed Sep. 10, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a device and a method for calculating trapping parameters by measuring short-circuit current decay under a reverse bias voltage.

Description of the Related Art

An isothermal current decay theory holds that trapping parameters of any energy level can be calculated according to the current decay characteristics of an actuated material in an isothermal condition. In detrapping process of trapped charge carriers in the isothermal condition, the carriers trapped in shallow traps in the material are earlier released than those trapped in deep traps, and the thermally released current varies with the time, which directly reflects the trap distribution parameters.

Based on the above theory, methods for analyzing the trapping parameters under a reverse bias voltage have been developed. However, the methods are low in calculation accuracy and complex in calculation process, and can only be applied to samples having thickness of several micrometers.

### SUMMARY OF THE INVENTION

In view of the above-described problems, it is one objective of the invention to provide a device and a method for calculating trapping parameters by measuring short-circuit current decay under a reverse bias voltage. The device and the method of the invention are applicable to trapping tests of inorganic insulating materials, such as alumina and machinable ceramic, as well as polymeric insulation materials, and are adapted to calculate trapping densities distributed at different energy levels based on the theory of the isothermal current decay.

To achieve the above objective, in accordance with one embodiment of the invention, there is provided a device for calculating trapping parameters by measuring short-circuit current decay under a reverse bias voltage. The device comprises: a vacuum chamber, an experiment table, a lower electrode, a shielding layer, an upper electrode, a direct current charging module, a switch, a short-circuit measuring system adapted to work under a reverse bias voltage, and a computer. The vacuum chamber comprises a door. The short-circuit measuring system under the reverse bias voltage comprises: a short circuit configured to discharge free charges of a test sample, a detrapping current measuring circuit, and a selective switch. The detrapping current measuring circuit comprises: a reverse bias voltage source and a microammeter. The microammeter comprises a signal output terminal. The experiment table, the lower electrode, the shielding layer, the test sample, and the upper electrode are disposed in the vacuum chamber. The lower electrode, the shielding layer, the test sample, and the upper electrode are disposed on the experiment table from the bottom up. The upper electrode is connected to the direct current charging module via the switch. The upper electrode and the lower electrode are electrically connected via the short-circuit measuring system under the reverse bias voltage. The short circuit configured to discharge free charges of the test sample or the detrapping current measuring circuit is selectively electrically connected under the control of the selective switch. The reverse bias voltage source and the microammeter are connected in series. The signal output terminal of the microammeter is connected to the computer, and the computer is connected to and controls the selective switch.

In a class of this embodiment, wherein the selective switch adopts a magnetic coupling linear actuator; a moving terminal of the magnetic coupling linear actuator is connected to the upper electrode via a conducting wire; a first terminal of the short circuit and a first terminal of the detrapping current measuring circuit are connected to two static contacts coordinated with the moving terminal of the magnetic coupling linear actuator, respectively; and both a second terminal of the short circuit and a second terminal of the detrapping current measuring circuit are connected to the lower electrode.

In a class of this embodiment, the vacuum chamber is a constant temperature vacuum chamber; a metal heating box is disposed beneath the lower electrode; and a thermocouple is disposed inside the metal heating box.

In a class of this embodiment, an infrared heating quartz tube and a desiccant are disposed inside the constant temperature vacuum chamber.

In a class of this embodiment, cables of both the short circuit and the detrapping current measuring circuit are coaxial shielded cables.

In accordance with one embodiment of the invention, there is provided a method for calculating trapping parameters by measuring short-circuit current decay under a reverse bias voltage using the above device. The method comprises:
A) opening a door of a constant temperature vacuum chamber, placing the test sample between the upper electrode and the shielding layer, ensuring that a contact surface between the test sample and the upper electrode is clean, and closing the door of the constant temperature vacuum chamber;
B) preheating the test sample using a heating box, applying the direct current charging voltage to the upper electrode using the direct current charging module to inject electric charges into the test sample; stopping applying the direct current charging voltage on the upper electrode when the injection of the electric charges is finished;
C) controlling the selective switch by the computer to connect the short circuit configured to discharge free charges of the test sample to remove free charges from the surface of the test sample; and
D) controlling the selective switch by the computer, disconnecting the short circuit and connecting the detrapping current measuring circuit to connect a series circuit formed by the test sample, the microammeter, and the reverse bias voltage source; measuring a thermostatic short-circuit current decay by the microammeter, sampling and recoding the thermostatic short-circuit current decay by the computer, calculating trapping densities distributed at different energy levels using measured thermostatic short-circuit current decay based on a theory of thermostatic current decay; in which, the theory of the thermostatic current decay is that assuming a retrapping possibility of thermally released carriers is equal to zero, equations involving a trap level Eₜ, an isothermal current density J, and a trap density Nₜ are as follows:

$$\{ \begin{matrix}{E}_{t} = k T ln ( γ t ) \\ J = \frac{qdk T}{2 t} {f}_{0} ( {E}_{t} ) {N}_{t} ( {E}_{t} )\end{matrix}$$

in which, Eₜ represents the trap level, k represents a Boltzmann constant, T represents an absolute temperature, γ represents an electron vibration frequency, t represents a time, J represents the isothermal current density, q represents an electron charge, d represents a thickness of the test sample, f₀(E) represents an initial trap occupancy, Nₜ(Eₜ) represents a function of trap level distribution; an energy of an electron trap is calculated by defining a bottom of a conduction band as a zero point; and an energy of a hole trap is calculated by defining a top of a valence band as a zero point.

In a class of this embodiment, in B), the test sample is preheated by the heating box at a temperature of between 50 and 60° C. for between 20 and 30 min.

In a class of this embodiment, in B), when the electric charges are injected into the test sample, an electric field intensity for the injection is 40 kV/mm, a duration of the injection is 30 min, and a temperature for the injection is 50° C.

Advantages of the device and the method for calculating trapping parameters by measuring short-circuit current decay under a reverse bias voltage according to embodiments of the invention are summarized as follows:

The test sample is placed inside the constant temperature vacuum chamber for ensuring stable experimental conditions and excellent electromagnetic shielding. When the reverse bias voltage is applied to the test sample, the positive charges and the negative charges respectively move towards the electrodes in the vicinity, therefore moving out of the medium. Thus, the charge distribution state will not be destroyed, the charge dissipation in the short transportation to the electrodes in the vicinity is negligible, and the retrapping process of the detrapped carrier is also negligible when the bias electric field is high enough, which satisfies the actual condition. The above-descripted processes make sure that measurement of the short-circuit current decay is accurate, and the calculation of the trapping parameters is convenient and fast. In addition, the shielding layer is arranged on one side of the test sample, so that the injected charges have only one polarity and the hole trap and the electron trap are therefore differentiated.

### BRIEF DESCRIPTION OF THE DRAWINGS

The invention is described hereinbelow with reference to the accompanying drawings, in which:

FIG. 1 is a structure diagram of a device for calculating trapping parameters by measuring short-circuit current decay under a reverse bias voltage in accordance with one embodiment of the invention; and

FIG. 2 is a circuit schematic diagram of a short-circuit current measuring system adapted to work under a reverse bias voltage in accordance with one embodiment of the invention.

### DETAILED DESCRIPTION OF THE EMBODIMENTS

For further illustrating the invention, experiments detailing a device and a method for calculating trapping parameters by measuring short-circuit current decay under a reverse bias voltage are described below. It should be noted that the following examples are intended to describe and not to limit the invention.

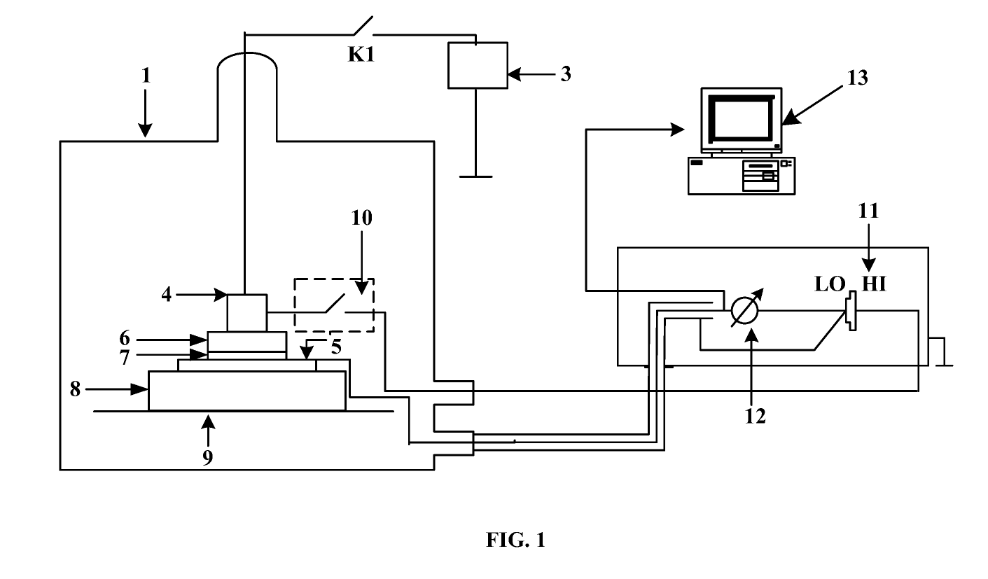

A device for calculating trapping parameters by measuring short-circuit current decay under a reverse bias voltage is illustrated in FIG. 1. The device comprises a vacuum chamber 1 comprising a door to ensure stability of experimental conditions and excellent electromagnetic shielding. An experiment table 9 is disposed in the vacuum chamber 1. A lower electrode 5, a shielding layer 7, a sample 6 to be tested, and an upper electrode 4 are disposed on the experiment table 9 from the bottom up. The upper electrode 4 is connected to a DC charging module 3 via a switch K1. Electric charges are injected in a mode of electrode contact. The electric charges can be injected in vacuum environment. The shielding layer 7 is embedded between the sample 6 to be tested and the lower electrode 5 to effectively inhibit the lower electrode 5 from injecting the electric charges into the sample 6 to be tested and to ensure that only the upper electrode 4 is able to inject unipolar electric charges. By selecting the polarity of the injected voltage, the device is able to respectively inject electrons or holes into a surface layer of the sample to be test, so that the hole trap and the electron trap are subtly differentiated.

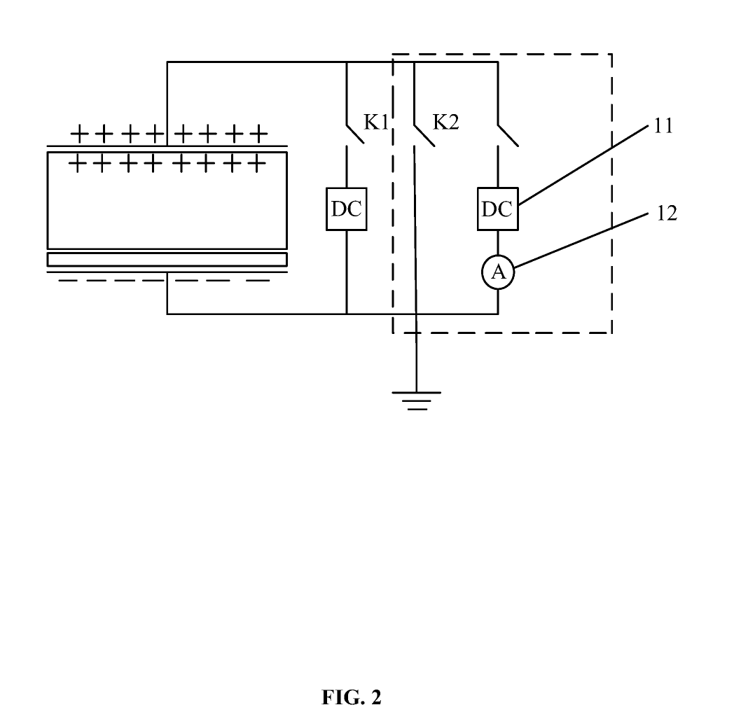

As shown in FIG. 2, a short-circuit measuring system under reverse bias voltage is connected between the upper electrode 4 and the lower electrode 5. The short-circuit measuring system under reverse bias voltage comprises: a short circuit configured to discharge free charges of a test sample and a detrapping current measuring circuit, both of which are selectively electrically connected under the control of a selective switch K2. The short circuit configured to discharge free charges of the test sample is adapted to remove free charges on a surface of the sample 6 to be tested before the measurement of short-circuit current decay. The detrapping current measuring circuit comprises: a reverse bias voltage source 11 and a microammeter 12 connected in series for measuring short-circuit current decay. A signal output terminal of the microammeter 12 is connected to a computer 13, and the computer 13 is connected to and controls the selective switch K2.

The selective switch K2 is adapted to separately connect the short circuit and the detrapping current measuring circuit under the control of the computer 13. The selective switch K2 adopts a magnetic coupling linear actuator 10. A moving terminal of the magnetic coupling linear actuator 10 is connected to the upper electrode 4 via a conducting wire. A first terminal of the short circuit and a first terminal of the detrapping current measuring circuit are connected to two static contacts coordinated with the moving terminal of the magnetic coupling linear actuator 10, respectively. Both a second terminal of the short circuit and a second terminal of the detrapping current measuring circuit are connected to the lower electrode 5. Under the control of the computer 13, the moving terminal of the magnetic coupling linear actuator 10 adopts linear motion. When the moving terminal of the magnetic coupling linear actuator 10 contacts with a first static contact connected to the short circuit, the short circuit is connected while the detrapping current measuring circuit is disconnected. When the moving terminal of the magnetic coupling linear actuator 10 contacts with a second static contact connected to the detrapping current measuring circuit, the detrapping current measuring circuit is connected while the short circuit is disconnected. The use of the magnetic coupling linear actuator 10 as the selective switch K2 is advantageous in its convenience in controlling, accurate regulation, and small vibration.

As the isothermal short-circuit current decay measured in condition of constant temperature is able to improve the accuracy of the experiment result, herein, the vacuum chamber 1 is a constant temperature vacuum chamber. A metal heating box 8 is disposed beneath the lower electrode 5, and a thermocouple is disposed inside the metal heating box 8. The metal heating box 8 is adapted to heat the test sample to ensure that the test sample reaches a preset temperature and maintains the preset temperature in the measurement process. For further ensuring the thermostatic effect in the constant temperature vacuum chamber, an infrared heating quartz tube is disposed inside the constant temperature vacuum chamber. The infrared heating quartz tube and the thermocouple together form a heating device, which realizes the thermostatic function in the constant temperature vacuum chamber under the control of the computer 13. Desiccant is placed in constant temperature vacuum chamber to control humidity in the constant temperature vacuum chamber. Cables of both the short circuit and the detrapping current measuring circuit are coaxial shielded cables, which cooperate with the constant temperature vacuum chamber to ensure the electromagnetic shielding effect and improve the accuracy of the measurement results.

A method for calculating trapping parameters by measuring short-circuit current decay under the reverse bias voltage comprises the following steps:
A) opening the door of the constant temperature vacuum chamber, placing the sample 6 to be tested between the upper electrode 4 and the shielding layer 7, ensuring that a contact surface between the sample 6 to be tested and the upper electrode 4 is clean, and closing the door of the constant temperature vacuum chamber;
B) preheating the sample 6 to be tested using the heating box, applying the direct current charging voltage to the upper electrode using the DC charging module to inject electric charges into the sample 6 to be tested; removing the applied DC charging voltage from the upper electrode 4 when the injection of the electric charges is finished; to ensure that the test sample has identical temperature on each part, the sample 6 to be tested is preheated at between 50 and 60° C. for between 20 and 30 min by the heating box. When the electric charges are injected into the test sample, an electric field intensity for the injection is 40 kV/mm, a duration of the injection is 30 min, and a temperature for the injection is 50° C., which enables the electric charges to be fully injected into the test sample.
C) controlling the selective switch K2 by the computer 13, connecting the short circuit configured to discharge free charges of the test sample to remove free charges from the surface of the sample 6 to be tested to avoid impacts of the existence of the free charges on a value of the short-circuit current decay; and
D) controlling the selective switch by the computer, disconnecting the short circuit and connecting the detrapping current measuring circuit to connect a series circuit formed by the test sample, the microammeter, and the reverse bias voltage source; measuring a thermostatic short-circuit current decay by the microammeter, sampling and recoding the thermostatic short-circuit current decay by the computer, calculating trapping densities distributed at different energy levels using measured thermostatic short-circuit current decay based on a theory of thermostatic current decay; in which, the theory of the thermostatic current decay is that assuming a retrapping possibility of thermally released carriers is equal to zero, equations involving a trap level Eₜ, an isothermal current density J, and a trap density Nₜ are as follows:

$$\{ \begin{matrix}{E}_{t} = k T ln ( γ t ) \\ J = \frac{qdk T}{2 t} {f}_{0} ( {E}_{t} ) {N}_{t} ( {E}_{t} )\end{matrix}$$

in which, Eₜ represents the trap level, k represents a Boltzmann constant, T represents an absolute temperature, γ represents an electron vibration frequency, t represents a time, J represents the isothermal current density, q represents an electron charge, d represents a thickness of the test sample, f₀(E) represents an initial trap occupancy, Nₜ(Eₜ) represents a function of trap level distribution; an energy of an electron trap is calculated by defining a bottom of a conduction band as a zero point; and an energy of a hole trap is calculated by defining a top of a valence band as a zero point.

Compared with the prior art, the device and the method for calculating trapping parameters by measuring short-circuit current decay under a reverse bias voltage have the following advantages in accordance with embodiments of the invention:
1. It is more accurate to measure the isothermal short-circuit current decay and convenient and fast to calculate the trapping parameters. In use, the sample 6 to be tested in the isothermal vacuum chamber is applied with a reverse bias voltage, the positive charges and the negative charges move towards heteropolar electrodes respectively, so that the charged electric charges move out of the dielectric material without destroying the initial distribution state of the charges. The charge dissipation produced in the short-distance transportation towards the heteropolar electrodes is very weak and at the same time the retrapping possibility of the detrapped carrier under the high bias magnetic field is negligible, which accord with the theoretical model of the isothermal current decay and the actual condition and ensure the accuracy and practicability in calculating trap distribution parameters.
2. The isothermal short-circuit current decay is measured by applying a reverse bias voltage to calculate the trap distribution. When the applied reverse bias electric field is high enough, the retrapping possibility of the detrapped carriers can be decreased. The method and the device of the invention are more adaptable to measure test samples having relative large thickness (within a range of between several tens of μm and several mm) and provide effective analyzing means for surface charging of the solid dielectric medium and the impact of the surface charging on the surface flashover performance
3. The charges are injected in the mode of electrode contact. The positive charges and the negative charges are injected into the medium in vacuum, which avoids surface flashover in the presence of the applied high voltage. In the meanwhile, the vacuum chamber has excellent electromagnetic shielding effect on the measured weak current signal, therefore ensures the accuracy of the experiment results.
4. The shielding layer 7 is embedded between the sample 6 to be tested and the lower electrode 5, which is able to effectively inhibit the lower electrode 5 from injecting charges to the sample 6 to be tested, thus it is ensured that only the upper electrode 4 is injected with unipolar electric charges. By selecting the polarity of the externally applied voltage, electrons or holes are injected into the upper surface of the sample 6 to be tested, so that the hole trap and the electron trap are subtly differentiated. The injection of the charges and the measurement of the isothermal short-circuit current decay are both performed in the vacuum chamber with constant temperature, and all the measuring cable wires are coaxial shielded cables, thus, the accuracy of the measurement results are improved.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A device for calculating trapping parameters by measuring short-circuit current decay under a reverse bias voltage, the device comprising:
a) a vacuum chamber, the vacuum chamber comprising a door;
b) an experiment table;
c) a lower electrode;
d) a shielding layer;
e) an upper electrode;
f) a direct current charging module;
g) a switch;
h) a short-circuit measuring system adapted to work under a reverse bias voltage, the short-circuit measuring system comprising: a short circuit configured to discharge free charges of a test sample, a detrapping current measuring circuit, and a selective switch; the detrapping current measuring circuit comprising: a reverse bias voltage source and a microammeter; the microammeter comprising a signal output terminal; and
i) a computer;
wherein
the experiment table, the lower electrode, the shielding layer, the test sample, and the upper electrode are disposed in the vacuum chamber;
the lower electrode, the shielding layer, the test sample, and the upper electrode are disposed on the experiment table, in that order, from the bottom up;
the upper electrode is connected to the direct current charging module via the switch; the upper electrode and the lower electrode are electrically connected via the short-circuit measuring system;
either the short circuit or the detrapping current measuring circuit is in a conducting state under the control of the selective switch;
the reverse bias voltage source and the microammeter are connected in series; and
the signal output terminal of the microammeter is connected to the computer; and the computer is connected to and controls the selective switch.

2. The device of claim 1, wherein the selective switch adopts a magnetic coupling linear actuator; a moving terminal of the magnetic coupling linear actuator is connected to the upper electrode via a conducting wire; a first terminal of the short circuit and a first terminal of the detrapping current measuring circuit are connected to two static contacts coordinated with the moving terminal of the magnetic coupling linear actuator, respectively; and both a second terminal of the short circuit and a second terminal of the detrapping current measuring circuit are connected to the lower electrode.

3. The device of claim 2, wherein the vacuum chamber is a constant temperature vacuum chamber; a metal heating box is disposed beneath the lower electrode; and a thermocouple is disposed inside the metal heating box.

4. The device of claim 3, wherein an infrared heating quartz tube and a desiccant are disposed inside the constant temperature vacuum chamber.

5. The device of claim 4, wherein cables of both the short circuit and the detrapping current measuring circuit are coaxial shielded cables.

6. A method for calculating trapping parameters by measuring short-circuit current decay under a reverse bias voltage using the device of claim 1, the method comprising:
A) opening a door of a constant temperature vacuum chamber, placing the test sample between the upper electrode and the shielding layer, ensuring that a contact surface between the test sample and the upper electrode is clean, and closing the door of the constant temperature vacuum chamber;
B) preheating the test sample using a heating box, applying the direct current charging voltage to the upper electrode using the direct current charging module to inject electric charges into the test sample; and removing the applied direct current charging voltage from the upper electrode when the injection of the electric charges is finished;
C) controlling the selective switch by the computer to connect the short circuit to remove free charges from the surface of the test sample; and
D) controlling the selective switch by the computer, disconnecting the short circuit and connecting the detrapping current measuring circuit to connect a series circuit formed by the test sample, the microammeter, and the reverse bias voltage source; measuring a thermostatic short-circuit current decay by the microammeter, sampling and recoding the thermostatic short-circuit current decay by the computer, calculating trapping densities distributed at different energy levels using measured thermostatic short-circuit current decay based on a theory of thermostatic current decay; in which, the theory of the thermostatic current decay is that assuming a retrapping possibility of thermally released carriers is equal to zero, equations involving a trap level Et, an isothermal current density J, and a trap density Nt are as follows:
$$\{ \begin{matrix}{E}_{t} = k T ln ( γ t ) \\ J = \frac{qdk T}{2 t} {f}_{0} ( {E}_{t} ) {N}_{t} ( {E}_{t} )\end{matrix}$$
in which, Eₜ represents the trap level, k represents a Boltzmann constant, T represents an absolute temperature, γ represents an electron vibration frequency, t represents a time, J represents the isothermal current density, q represents an electron charge, d represents a thickness of the test sample, f₀(E) represents an initial trap occupancy, Nₜ(Eₜ) represents a function of trap level distribution; an energy of an electron trap is calculated by defining a bottom of a conduction band as a zero point; and an energy of a hole trap is calculated by defining a top of a valence band as a zero point.

7. The method of claim 6, wherein in B), the test sample is preheated by the heating box at a temperature of between 50 and 60° C. for between 20 and 30 min.

8. The method of claim 7, wherein in B), when the electric charges are injected into the test sample, an electric field intensity for the injection is 40 kV/mm, a duration of the injection is 30 min, and a temperature for the injection is 50° C.
